(19) United States
(12) Patent Application Publication
(10) Pub. No.: US 2024/0400351 A1
(43) Pub. Date: Dec. 5, 2024

(54) Manhole Cover

(71) Applicant: Oliver's Hire Solutions Ltd, Northampton (GB)

(72) Inventor: Erion Ismailanji, Northampton (GB)

(73) Assignee: Oliver's Hire Solutions Ltd, Northampton (GB)

(21) Appl. No.: 18/672,544

(22) Filed: May 23, 2024

(30) Foreign Application Priority Data
Jun. 1, 2023 (GB) 2308180.5

(51) Int. Cl. B66C 1/66

(52) U.S. Cl. CPC B66C 1/66

(57) ABSTRACT

A manhole platform is provided for mounting on an upper slab of a concrete manhole to allow the manhole to be lifted into or out of position and to provide a safe platform on top for users to stand on. The manhole platform has a support plate for mounting on an upper surface of the upper slab to cover an access hole of the upper slab. A clamping bracket is provided that extends downwardly from a lower side of the support plate, through the access hole, to clamp the manhole platform to the upper slab. An actuator is located above an upper surface of the support plate to operate the clamping bracket between a clamping position in which the manhole platform is clamped to the upper slab, and an unclamped position in which the manhole platform can be lifted off of the upper slab.

### CROSS-REFERENCE TO RELATED APPLICATION

The present application claims priority to Great Britain Patent Application No. 2308180.5 filed on Jun. 1, 2023, which is incorporated herein by reference in its entirety.

### FIELD OF INVENTION

The present invention relates to construction, specifically within groundworks and foundations. The invention aims to make the process of assembling concrete holes (inspection chambers) safer and more efficient.

### BACKGROUND TO THE INVENTION

FIG. 1 shows the parts of a typical concrete manhole 1. The manhole 1 consists of a lower attaching portion 2, a central tunnel 3, and an upper slab 4. The upper slab 4 has a small access hole 6 that allows people to enter the manhole 1. A ladder 7 is positioned in the central tunnel 3 to allow a person entering the manhole 1 to safely get to and from the bottom of the manhole. The manhole 1 is used to provide access to pipelines 5 or other utilities that are buried deep below ground level in deep excavations. The typical positioning of a manhole 1 in deep excavations is shown in FIG. 2. This shows the pipeline 5 that can be accessed using the hole. It also shows that the upper slab 4 has a further covering 8 positioned on its upper side to cover the access hole 6.

Typically, a manhole 1 as shown in FIGS. 1 and 2 is fixed in position in the following manner. First, the manhole 1 is located appropriately above the relevant pipeline 5 or utility. Shuttering is then provided around the manhole 1 and concrete is poured around the manhole to hold it in position. Surrounding the manhole with concrete is the standard construction that is required in the UK for infrastructure, commercial, and domestic construction projects as it has been proven to produce safe and durable results. Constructing the manhole in this way prevents ground water from penetrating through the manhole ring, which is important for the manhole to function properly.

When locating the manhole 1 in position the components of the manhole are positioned in turn. First, the lower attaching portion 2 is located and fixed in position relative to the pipeline 5 or utility, then the central tunnel 3 is located upon the lower attaching portion 2, then finally the upper slab 4 is located in position at the upper end of the central tunnel 3. Most commonly, the upper slab 4 will be lowered into position using chains attached to the arm of an excavator. It has been found to be difficult to lower upper slabs into position using this method. Further, it is also difficult for individuals to safely access the manhole and adjust the upper slab into position. In light of this there is a need for an improved method and apparatus for locating upper slabs of manholes into position.

### SUMMARY OF THE INVENTION

The present invention provides a manhole platform comprising:
a support plate for mounting on an upper surface of a concrete manhole, the support plate having an upper side and a lower side;
a clamping bracket extending downwardly from the lower side; and
an actuator positioned to be operable from the upper side of the support plate; wherein
the clamping bracket comprises an attaching portion and a clamping portion;
the attaching portion is attached to the support plate at a proximal end and extends downwardly to a distal end;
the clamping portion is attached to the distal end of the attaching portion;
the clamping portion can be moved between a clamping position and an unclamped position;
in the clamping position the clamping portion has a clamping width in a first direction parallel to the lower side of the support plate;
in the unclamped position the clamping portion has an unclamped width in the first direction parallel to the lower side of the support plate;
the clamping width is at least 10% greater than the unclamped width;
in both the clamping position and the unclamped portion the attaching portion has a width that is less than or equal to the unclamped width;
the actuator is operable to move the clamping portion between the clamping position and the unclamped position; and
a safety cage is formed on the upper surface of the support plate and extends upwardly therefrom.

The manhole platform is intended for mounting on top of the upper slab of a manhole having an access hole formed therethrough, as discussed above. In particular, the manhole platform can be positioned on the upper side of an upper slab with the lower side of the manhole platform immediately adjacent an upper side of the upper slab and with the clamping bracket extending through the access hole of the upper slab. The clamping bracket is used to fix the manhole platform in position on the upper side of the upper slab. The unclamped width of the clamping portion will be less than a width of the access hole, this allows the manhole platform to be positioned on the upper side of the upper slab. The clamping width of the clamping portion will be wider than the width of the access hole, such that operating the actuator to move the clamping portion from the unclamped position to the clamping position will act to attach the manhole platform to the upper slab. In order to make the attachment secure it is generally advantageous that the attaching portion has a length from the proximal end to the distal end is the same as the thickness of the upper platform at the access hole.

The actuator is operable from the upper side of the manhole platform such that it is not necessary to access the lower side of the manhole platform to operate the clamping bracket and the manhole platform can be clamped in position from the upper side of the manhole platform.

Having a platform mounted on the upper side of the upper slab can be advantageous in that it can allow the upper slab to be positioned more easily, it can also provide a safe platform for an individual to be located on the upper side of the upper slab, without danger of falling through the access hole. Together these features can significantly improve the safety and efficiency of locating the upper platform of manholes.

In embodiments of the invention the clamping portion may be able to be locked in the clamped position. This can be achieved using any suitable locking mechanism. Advantageously, the locking mechanism should be operable from the upper side of the platform and may be operable by the actuator.

The support plate may be formed in any suitable manner. In embodiments of the invention the support plate may be a substantially flat plate that conforms to, or is smaller than, the upper surface of the upper slab of a manhole on which it is intended to be mounted. It is advantageous that the support plate is the same size as, or smaller than, the upper slab of the manhole as this avoids the support plate protruding over an edge of the upper slab. As will be readily appreciated, it may also be advantageous that the upper slab completely covers the access hole of the upper slab. This is beneficial as it prevents a person located on the upper surface of the upper slab from falling through the access hole.

In order to improve safety of the manhole platform, a safety cage, safety railing, or any other equivalent structure is formed on the upper surface of the support plate and extends upwardly therefrom. The safety cage may comprise railings extending completely around a periphery of the upper surface of the upper platform to provide an enclosure in which an operator can be safely located. Alternatively, the safety cage may comprise railings extending only partially around a periphery of the upper surface of the upper platform. It is generally preferable that the safety cage is open at an upper side. In embodiments of the invention the safety cage may extend outwardly from the support plate.

Any safety cage, or safety railing or equivalent structure may comprise an openable gate to allow a person to enter and leave the structure. An openable gate may be formed in any manner apparent to a person skilled in the art. In order to provide better security an openable gate may comprise a lock such that the gate can be locked close.

Any safety cage, or safety railing or equivalent structure may comprise a ladder support mounted on an outer side to allow an operator to climb up onto the support plate. The ladder may be formed in any manner apparent to a person skilled in the art.

A manhole platform according to the present invention may comprise one or more attaching points for attaching chains or ropes for lifting the platform. The attaching points may be formed in any manner apparent to the person skilled in the art. They may comprise apertures, fixing loops, or any other fixture to which a rope or chain can be attached. The attaching points may be formed at the support plate, for example on an upper surface of the support plate, or at any fixture attached to the support plate. As will be readily understood, the attaching points should be accessible when the manhole platform is clamped to an upper slab of a manhole and should be positioned or formed accordingly. A manhole platform may have any suitable number of attaching points. For example, a manhole platform according to the present invention may have one, two, three, four, five, six, or more attaching points.

In embodiments of the invention the clamping bracket may be a simple manual bracket that is operated by moving the actuator between a first position and a second position. For example, the clamping portion may comprise one or more levers that are pivotably attached to the actuator, either directly or via a linkage, such that moving the actuator acts to pivot the lever to or from the clamping position to the unclamped position. In simple embodiments the actuator will be moved be directly pivotally attached to two or more levers and moving the actuator upwards and downwards to pivot the levers between the clamping position and the unclamped position. In such embodiments the actuator will also form at least part of the attaching portion.

In alternative embodiments the clamping bracket may be automated and the actuator may be a button, switch, or other control that acts to operate the clamping bracket. 5 For example, the clamping bracket may be operated by a motor that is controlled by the operation of the actuator. Automated clamping brackets may be formed in any manner apparent to the person skilled in the art. For example, the clamping portion may comprise two or more extendible members that extend to and from the unclamped position to and from the clamped position under the action of a motor or other actuating means.

The clamping width is at least 10% greater than the unclamped width. In embodiments of the present invention the clamping width may be at least 20%, at least 30%, at least 40%, at least 50%, at least 75% or at least 100% greater than the unclamped width. Generally, the clamping width should be greater than the width of an access hole that the manhole platform is intended to be used with and the unclamped width should be less than the width of an access hole that the manhole platform is intended to be used with. This ensures that in the clamping position the manhole platform will be clamped to the upper slab through the access hole, whilst in the unclamped position the manhole platform can be freely lowered onto or lifted off the upper slab.

Further features and advantages of the present invention will be apparent from the embodiment of the present invention that is shown in the Drawings and is described below.

### BRIEF DESCRIPTION OF THE DRAWINGS

FIG. 1 shows the parts of a typical concrete manhole;

FIG. 2 shows the positioning of the concrete manhole of FIG. 1 in position in the ground;

FIG. 3 is a first isometric view of an embodiment of an embodiment of a manhole platform according to the present invention;

FIG. 4 is a second isometric view of the manhole platform of FIG. 3;

FIG. 5 is a plan view of the manhole platform of FIGS. 3 and 4; and

FIG. 6 is a side view of the manhole platform of FIGS. 3 to 5.

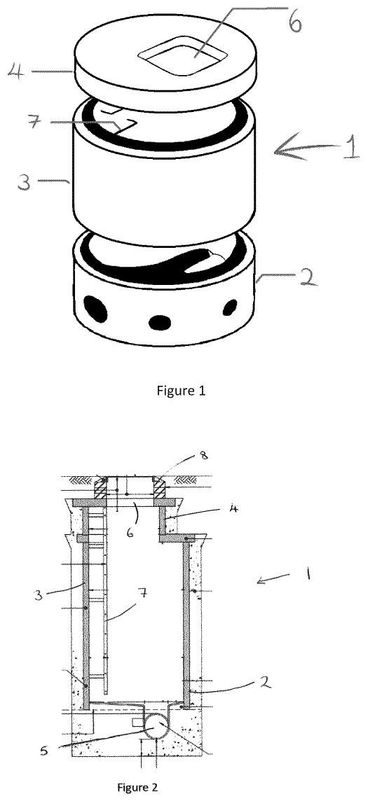

### DETAILED DESCRIPTION OF THE INVENTION

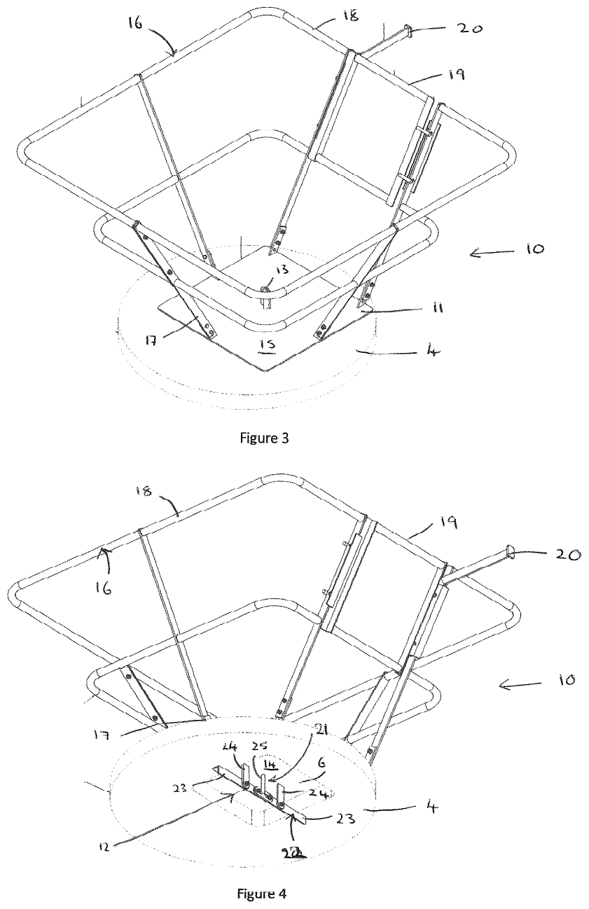

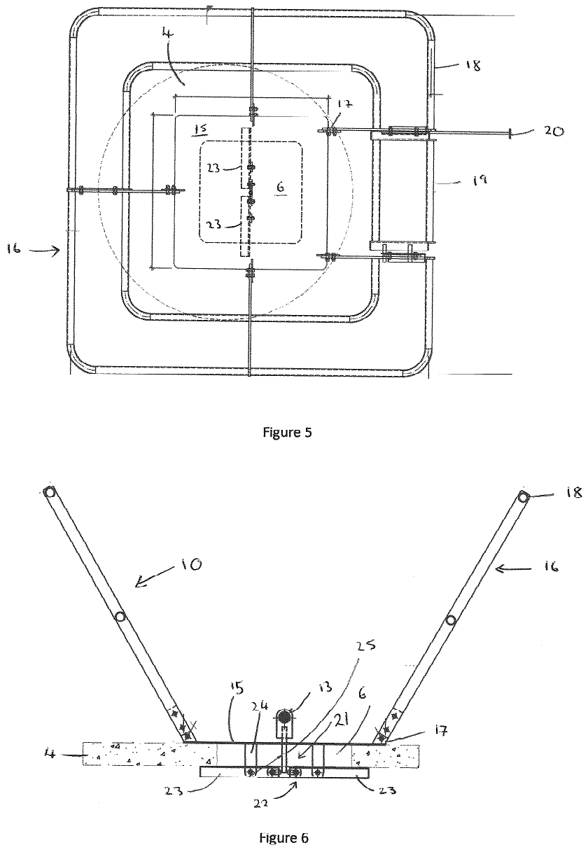

An embodiment of a manhole platform 10 according to the present invention is shown in FIGS. 3 to 6. The manhole platform 10 comprises a support plate 11, a clamping bracket 12 extending from a lower side 14 of the support plate, an actuator 13 formed above an upper side 15 of the support plate, and a safety cage 16 formed about the upper side of the support plate. The manhole platform 10 is shown mounted on an upper slab 4 of a manhole 1 in FIGS. 3 and 4. The upper slab 4 has a square access hole 6 formed therethrough. The support plate 11 is square and is sized to completely cover the access hole 6 when the manhole platform 10 is clamped to the upper slab 4.

The safety cage 16 consists of railing extending around a periphery of the support plate 11 and is angled outwards from a lower end 17, attached to the support plate 11, and an upper side 18. A lockable gate 19 is provided in one side of the safety cage 16 to allow operators to enter and leave the safety cage. A ladder support 20 is formed at the upper side 18 of the railing adjacent to the lockable gate 19. A ladder (not shown) may be removably mounted to the ladder support when required.

The clamping bracket 12 allows the manhole platform 10 to be removably clamped to the upper slab 4. The clamping bracket 12 is shown in a clamping position in FIGS. 3 to 6. The clamping bracket comprises an attaching portion 21 and a clamping portion 22. The clamping portion 22 consists of two pivotable levers 23 that can be moved between a clamping position in which they are substantially parallel to the support plate 11 and an unclamped position in which they are at an angle to the support plate 11. The attaching portion consists of two braces 24 that are fixedly attached at a proximal end to the lower side 14 of the support plate 11 and at a distal end are pivotably attached to a pivotable lever 23 a short distance from an inner end of the pivotable lever 23. The attaching portion further comprises a rod 25 that is pivotably attached at a lower end to an inner end of each pivotable lever 23 and that extends upwards, through the support plate 11 to the actuator 13.

The clamping bracket 12 can be operated in the following manner. In the unclamped position, a length from an outer end of a first pivotable lever 23 to an outer end of the second pivotable lever 23 is less than a width of the access hole 6 of the upper slab 4. This allows the manhole platform to be positioned on the upper side of the upper slab 4 such that the support plate 11 is in contact and parallel with the upper side of the upper slab 4 and the access hole 6 is completely covered. A user can then use the actuator 13 to move the pivotable levers 23 to the clamping position shown in FIGS. 3 to 6 in which the length from an outer end of a first pivotable lever 23 to an outer end of the second pivotable lever 23 is greater than a width of the access hole 6 of the upper slab 4. This clamps the manhole platform 10 to the upper slab 4.

Moving the clamping bracket 12 from the unclamped position to the clamped position is achieved by pushing the actuator 13 downwards. This will act to provide a downward force on the inner end of the pivotable levers 23 and they will pivot about their connection with the braces 24 to rotate from the unclamped position to the clamped position.

This operation is reversed to unclamp the manhole platform 10 from the upper slab 4. Pulling the actuator 13 upwards acts to provide an upward force on the inner end of the pivotable levers 23 and they will pivot about their connection with the braces 24 to rotate from the clamped position to the unclamped position. At this point the width of the clamping bracket 12 will be less than a width of the access hole 6 and the manhole platform will be able to be lifted off the upper slab 4.

The manhole platform 10 can be lowered into, or lifting out, of position by attaching chains or ropes to the safety cage 16 at an appropriate point. The manhole platform is substantially formed of structural steel.

Unless otherwise indicated in the claims or by context, any feature of the preferred embodiment described above can be included in a manhole platform according to the present invention independent of any other feature.

What is claimed is:

1. A manhole platform comprising:
a support plate for mounting on an upper surface of a concrete manhole, the support plate having an upper side and a lower side;
a clamping bracket extending downwardly from the lower side; and
an actuator positioned to be operable from the upper side of the support plate; wherein
the clamping bracket comprises an attaching portion and a clamping portion;
the attaching portion is attached to the support plate at a proximal end and extends downwardly to a distal end;
the clamping portion is attached to the distal end of the attaching portion;
the clamping portion is moveable between a clamping position and an unclamped position;
in the clamping position the clamping portion has a clamping width in a first direction parallel to the lower side of the support plate;
in the unclamped position the clamping portion has an unclamped width in the first direction parallel to the lower side of the support plate;
the clamping width is at least 10% greater than the unclamped width;
in both the clamping position and the unclamped position the attaching portion has a width that is less than or equal to the unclamped width;
the actuator is operable to move the clamping portion between the clamping position and the unclamped position; and
a safety cage is formed on the upper surface of the support plate and extends upwardly therefrom.

2. The manhole platform according to claim 1, wherein the clamping portion is lockable in the clamped position.

3. The manhole platform according to claim 1, wherein the support plate consists of a flat plate.

4. The manhole platform according to claim 1, wherein the safety cage includes an openable gate.

5. The manhole platform according to claim 1, wherein the safety cage includes a ladder support on an outer side.

6. The manhole platform according to claim 1, further comprising one or more attaching points attached to the upper side of the support plate.

7. The manhole platform according to claim 1, wherein the attaching portion of the clamping bracket comprises a bar or rod.

8. The manhole platform according to claim 1, further comprising one or more attaching points.

9. The manhole platform according to claim 8, wherein the attaching points are formed on an upper surface of the platform.

10. The manhole platform according to claim 1, wherein the clamping bracket is manual and is operated by moving the actuator between a first position and a second position.

11. The manhole platform according to claim 1, wherein the clamping bracket is automated and the actuator is a lever, switch, or button that acts to operate the clamping bracket.
